(19) United States
(12) Patent Application Publication
(10) Pub. No.: US 2009/0137279 A1
(43) Pub. Date: May 28, 2009

(54) MOBILE COMMUNICATION TERMINAL WITH A SINGLE ROW KEYPAD

(75) Inventor: Miika Silfverberg, Vantaa (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/916,304

(22) PCT Filed: Jun. 8, 2005
(86) PCT No.: PCT/EP05/06141

§ 371 Date: Nov. 10, 2008

(51) Int. Cl. H04M 1/00; G06F 3/02; G06F 3/041

(52) U.S. Cl. 455/566; 345/169; 345/173; 361/679.08

(57) ABSTRACT

A mobile communication terminal including a display and a a keypad having a single row of keys. At least some of the keys have a plurality of characters associated associate therewith. One of the keys indicates the completion of a word. The row of keys is disposed along the periphery of the display.

### BACKGROUND

1. Field

The disclosed embodiments relate to mobile communication terminals comprising a display; a keypad and processor means controlling the display means in accordance with the operation of the keypad. Further, the invention relates to a keypad for use with mobile communication terminals.

2. Background Art

Communication terminals, such as hand portable phones (mobile phones, smartphones) or handsets, are able to handle and exchange ever increasing amounts of data. However, data input is still a bottleneck in the handheld device usability: the existing solutions often take a lot of space (limiting e.g. the size of the display), and are still relatively slow and cumbersome to use.

Traditionally, hand held terminals are equipped with a 3*4 keypad with alphanumeric keys, the so called ITU-T keypad, also referred to as DTMF keypad as is incorporated in e.g. the GSM standard. The 12 keys of the ITU-T key have assigned thereto the digits 0-9 and some extra signs as well as a plurality of text characters—such as for example letters and the space to separate words. The keys that have assigned both letters and digits thereto are often referred to as alphanumerical keys.

When the keypad is used to enter a telephone number, the keystrokes are unambiguous, since the terminal will interpret the strokes as number related entries, and there is only one digit or symbol associated with a single key. However, when entering text, there are several characters assigned to most of the keys, and the resulting input is ambiguous.

One way of handling the disambiguation problem has been the so called multitap method, in which the desired character is indicated by a quick (within a predetermined timeout) repetitive depression of a key. Therefore, inputting of text for e.g. short messages or e-mail may require many keystrokes compared with the number of letters in the message.

Another way of handling the disambiguation problem has been the so called “predictive text input”, which determines from all the possible matches, the intended word. The method is based on embedded software that matches entered keystrokes with completed words from a linguistic database. This method requires less keystrokes than the multitap method to enter a given word or text, but it the linguistic database has its limitations and can therefore not always include all the words or names that a user may wish to write.

Communication terminals, such as Personal Digital Assistants (PDAs) and communicators have traditionally either operated with a substantially complete standard typewriter or computer keyboard, also refereed to as the “QWERTY” key board in the English language or with a touch screen based input method, with or without a stylus, such as handwriting recognition, often referred to as Graffiti, or by displaying a standard keyboard on the touchscreen. The advantage of using a touch screen based method evident when using a method like graffiti, in that the space available for the display is much larger than when a keyboard has to be accommodated on the terminal. This advantage is lost—at least when entering text—when a virtual keyboard is displayed on the touchscreen. Disadvantage of handwriting recognition using a stylus are that users have found it difficult to learn to write in a new way with the stylus, the low character entry speed, and the fact that one needs to use both hands for writing.

The QWERTY layout used in PC keyboards is by far the most widely used text input method in computing devices. Unfortunately it consists of very many keys, making it hard to fit in a handheld device. Some devices use an ‘almost full’ QWERTY keyboard (communicators, Blackberry devices, some PDA's etc). These devices seem to be more and more accepted, even overriding previous input methods such as Graffiti. However, a full keyboard takes a lot of space and limits the design of the handheld device a lot.

### SUMMARY

On this background, it would be advantageous to provide a mobile communication terminal of the kind referred to initially, which provides for an increased data entry rate and accuracy combined with a large available area for the display.

In one embodiment a terminal is provided comprising a display, a keypad comprising: a single row of keys, at least some of the keys having a plurality of characters associated therewith in one or more states of the terminal, and processor means controlling the display means in accordance with the operation of the keypad, the processor means being configured to disambiguate ambiguous keystrokes, and the single row of keys being disposed along the periphery of the display.

By arranging the keys for ambiguous character entry in one row that is disposed along the periphery of the display it becomes possible to construct a mobile communication terminal with a front surface having a large display surrounded by a narrow rim.

The row of keys can be disposed on the narrow rim along a side of the display, preferably relatively nearby the side of the display. Other keys of the keypad can be disposed along the other sides of the display. Thus, a terminal is obtained that has both an effective means for imputing data and a large space available for occupation.

The single row is preferably disposed below the display whereby the display is used in the landscape orientation during normal use.

In order to render the terminal even more compact, the terminal may comprise a stationary housing part on which the display is disposed and a movable housing part on which the single row of keys is disposed. The movable housing part can be a retractable slide or a folding flap or housing part.

In another embodiment a mobile communication terminal is provided comprising: a display, a keypad comprising a single row of keys, the row of keys including at least several keys having a plurality of characters associated therewith in a text entry mode of the terminal, and processor means controlling the display means in accordance with the operation of the keypad, the processor means being configured to disambiguate ambiguous keystrokes by determining word candidates that match a string of entered keystrokes, and to show one of the matching word candidates on the display, the single row of keys further including a key associated with the function of accepting a word candidate and/or adding a space after the last entered character in a text entry mode of the terminal.

By providing several keys having a plurality of characters associated therewith and a key for selecting a word proposed by disambiguation of ambiguous keystrokes in a single row, it becomes possible to create an effective text entry means that can be fitted in a very small terminal.

The single row of keys may further include a key associated with a shift function in a text entry mode of the terminal. The single row of keys may also include a key associated with a function of selecting/displaying another word candidate that matches the string of entered keystrokes.

Advantageously, the processor is configured to shift between a text entry mode and a number entry mode when two predetermined keys are activated simultaneously, so that users can easily enter numbers when writing a text.

In another aspect a mobile communication terminal is provided that is capable of handling telephone calls comprising: a display, a keypad comprising a single row of keys, wherein the single row of keys includes: at least ten keys that are each associated with a different one of the ten digits in a telephone number entry mode of the terminal, a key associated with the asterisk “*” symbol in the telephone number entry mode of the terminal, and a key associated with the square “#” symbol in the telephone number entry mode of the terminal.

By providing a single row of keys with the digits 0-9 and the symbols “#” and “*” associated therewith a telephone number entry device is provided that allows the construction of compact communication terminals with a large display.

The processor may be configured to shift between a text entry mode and a number entry mode when the key associated with the “*” symbol and the key associated with the “#” symbol are pressed simultaneously.

The aspects of the disclosed embodiments also provide a compact keypad for use with a hand-held communication terminal that allows high text entry rates and accuracy.

In one embodiment a keypad for use with a mobile computer terminal is provided with a single row of keys, wherein the single row of keys includes: at least several keys having a plurality of characters associated therewith, and a key associated with the function of accepting a word candidate and/or adding a space after the last entered character.

The single row of keys may further include a key associated with a shift function in a text entry mode of the terminal. The single row of keys may also include a key associated with a function of selecting another word candidate that matches a string of entered keystrokes.

The keys of the single row are preferably labeled with the characters and/or functions that are assigned thereto.

The keypad is an accessory keypad for connecting to a mobile communication terminal, preferably having its own housing. The housing may comprise two parts that are foldably connected to one another to obtain a very small accessory travel keypad.

In a further aspect, the disclosed embodiments provide a compact keypad for use with a hand-held communication terminal that allows high number entry rates and accuracy.

In one embodiment a keypad for use with a hand-held communication terminal is provided comprising a single row of keys, wherein the single row of keys includes: at least ten keys that are each associated with a different one of the ten digits in a telephone number entry mode of the terminal, a key associated with the asterisk “*” symbol in the telephone number entry mode of the terminal, and a key associated with the square “#” symbol in the telephone number entry mode of the terminal.

By arranging the keys with the digits assigned thereto in a single row, it becomes possible for the users to use two fingers instead of one for date entry, thereby increasing the obtainable number entry rate.

The single row of keys may include at least several keys having a plurality of characters associated therewith. The single row of keys may further include a key associated with the function of accepting a word candidate and/or adding a space after the last entered character.

Preferably, there are twelve keys in total in the row of keys, i.e. the same number of keys as in the standard (ITU-T) keypad presently used in mobile phones. Further, the keys are assigned the same functionality as the keypad of the standard (ITU-T) keypad, except for the distribution of the letters over the alphanumerical keys. The function of the individual keys is therefore familiar to mobile phone users. The distribution of the letters over the alphanumerical keys is closely modeled on the QWERTY keyboard (or other language version thereof) and therefore the layout of the letters is familiar to computer users. Since these two groups of users will largely overlap, the whole layout of the row of keys is easy accept and to learn for most of the users. The obtainable data entry rate is further increased by the effect that there is place enough in the single row of keys to use two fingers instead of one.

Further, features, advantages and properties of the mobile communication terminal and keypad according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 shows a front view and a top view of a mobile terminal according to an embodiment in a numeric mode,

FIG. 2 shows a front view and a top view of a mobile terminal according to an embodiment in a alpha mode,

FIGS. 3a to 3d show layouts of a row of keys for different languages,

FIG. 4 is a block diagram illustrating the general architecture of a mobile communication terminal in accordance with the disclosed embodiments,

FIG. 5 shows a second embodiment of a terminal that includes a slide with a row of keys disposed thereon to further reduce terminal size,

FIG. 6 shows a third embodiment of a terminal that has an elongated housing and includes a slide to further reduce terminal size,

FIG. 7 shows a fourth embodiment of a terminal that has a stick like housing,

FIG. 8 shows a fifth embodiment of a terminal that has a curved row of keys on a slidable part of the terminal,

FIG. 9 shows a sixth embodiment of a terminal with a folding housing and the row of keys divides over the two foldable housing parts,

FIG. 10 shows a seventh embodiment of a terminal that has two foldable wings with parts of the row of keys disposed thereon,

FIG. 11 shows an eighth embodiment of a terminal that has that has a foldable housing structure with a fold axis that coincides with the display and wings with parts of the row of keys disposed thereon,

FIG. 12 shows an ninth embodiment of a terminal that is provided with a touchscreen, and

FIG. 13 shows an accessory keypad that can be used with a mobile terminal.

### DETAILED DESCRIPTION

The user interface of the disclosed embodiments is generally for hand portable personal communication terminals having a limited display area and a limited set of input keys. This type of terminals comprises e.g. PDAs, Internet tablets, Communicators, smartphones, cellular phones, (car-) navigation devices and pagers.

The customers ask for handheld devices with a functionality that comes as close as possible to that of a laptop computer, i.e. a laptop computer in a smaller, lighter and more robust package and preferably including telephone and camera capacity. In order to fulfill these requirements the font surface of the terminal must be practically completely occupied by the display.

The disclosed embodiments will be described in the following with reference to a preferred embodiment according to which the concept is implemented in a Smartphone.

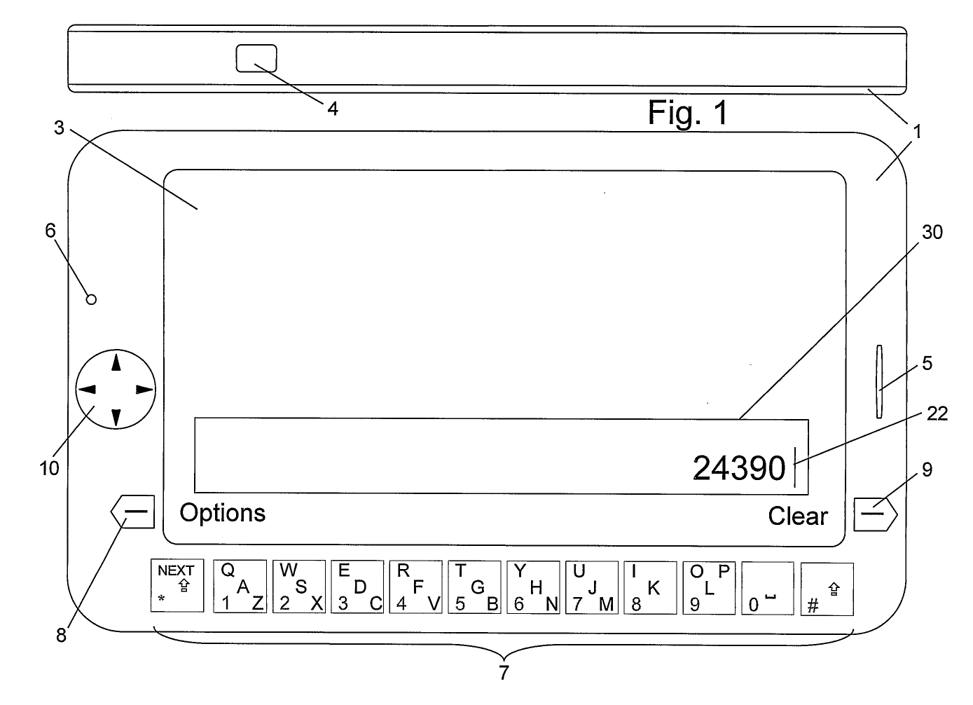

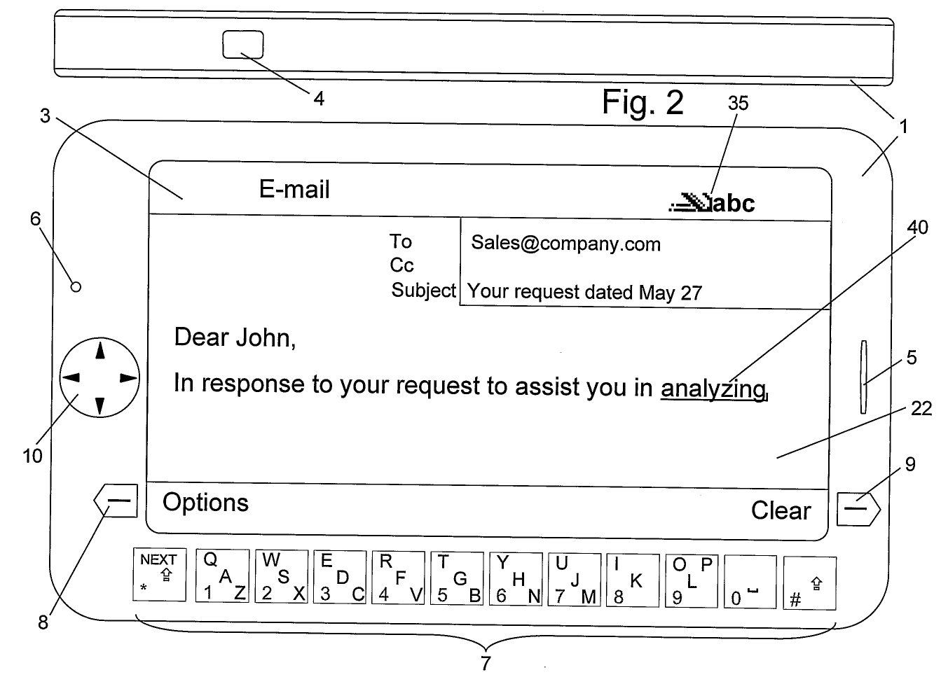

FIGS. 1 and 2 show front- and top views of a preferred embodiment of a smartphone according to the invention, and it will be seen that the smartphone, which is generally designated by 1, includes a housing that is shaped as a flat cuboid (with rounded-off edges). The two largest sides of the housing form the front and the rear surface of the smartphone 1.

A keypad 2, and a rectangular display 3, are disposed on the front surface. The display 3 is normally used in the landscape orientation. The user interface includes also an on/off button 4 (on top of the terminal), an earpiece 5, and a microphone 6. The smartphone 1 according to the preferred embodiment is adapted for communication via a cellular network, but could have been designed for a cordless network, or for voice over IP via the internet and a W-Lan connection as well. The keypad 2 includes a left softkey 8, a right softkey 9, a four way plus select navigation key 10 and one row of keys 7 with which the user can enter a telephone number, write a text such as messages (SMS), names (possibly associated with the phone number), e-mails, etc.

The right and left softkeys 8,9 are disposed on the rim surrounding the display close to the lower part of left and right side of the display 3 respectively. The functionality of the softkeys 8,9 depends on the mode of the smartphone 1 and the navigation in the menu by using a navigation key 10. The present functionality of the soft keys 8,9 and is shown in predetermined fields in the display 3 right next to the respective softkeys 8 and 9. The navigation key 10 is disposed on the rim left of the display 3.

The row of keys 7 includes twelve keys, and is disposed just below the display 3 on the narrow rim of the housing that surrounds the display. The row of keys 7 includes ten alphanumerical keys flanked by two further keys at the extremities of the row 7. The keys in the row are each provided with several labels, whereby labels that are active in the same mode of the smartphone 1 are located in the same position relative to the key with which they are associated. To further assist the user in identifying the different labels for different modes of the terminal a color scheme may best used (not shown), with e.g. all text entry related labels (a-z, [symbol] , [symbol] ) having a first color, and all number entry related labels (1-9, 0 and *, #) having another color. The labels can be printed either on or—next to the keys.

The number entry related labels of all the keys in the row are located in the lower left corner of the respective keys. The leftmost key of the row is provided in its lower left corner with an asterisk sign “*” and the rightmost key of the row is provided in its lower left corner with a square sign “#”. These symbols are used in telephone communication for control purposes, phone answering machines, bringing up remote bases, electronic banking, repeater control, indication of the number entry being complete and for phone number truncation.

The 10 alphanumerical keys are in their lower left corners labeled from left to right with each one of the digits 1 to 9 and 0.

In alpha-(or text enty-)mode each the alphanumerical keys is associated with a number of letters and/or special signs used in text editing. In the present embodiment for a smartphone intended to operate in the English language, the alphanumerical key labeling corresponds substantially a so called “QWERTY” keyboard in which the three letter related rows “q to p”, “a to 1” and “z to m” are superimposed onto the single row of alphanumerical keys. The “ [symbol] ” character for adding a space in a text string is unambiguously assigned to the “0” key, since this key also indicates that the entry of a word has been completed. Therefore, there are only 9 alphanumeric keys available in the row of keys in the present embodiment for assigning the 26 letters of the alphabet to. However, the “q to p” row of the “QWERTY” keyboard includes 11 keys. Therefore, the “p” has been added to the “9” key, to avoid the need for an additional key having only the letter “p” assigned therewith, at the price of a slight inconsistency when compared to the original QWERTY keyboard.

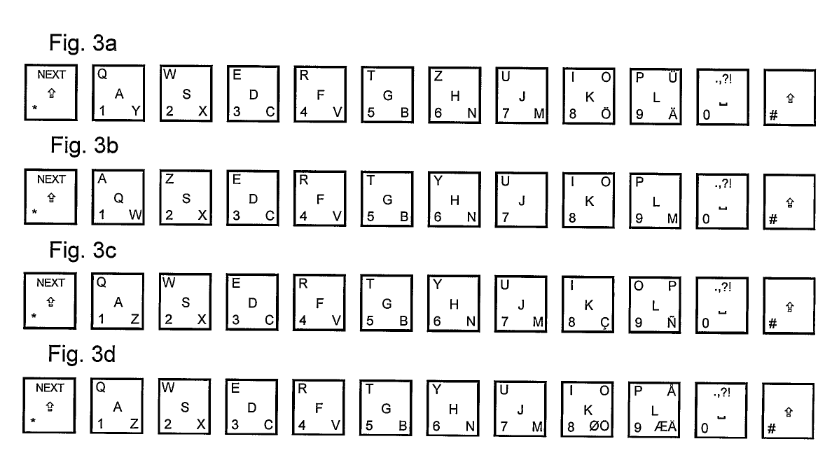

The layout of the row of keys 7 for various languages is illustrated in FIGS. 3a to 3d. FIG. 3a illustrates the layout for the German language. In order to accommodate three additional letters of the German alphabet four letters are associated with the “8” and “9” key, whilst all the other keys except the “0” key have assigned three letters each thereto (FIG. 3a). The layout of the German keyboard is slightly different from the layout of the English keyboard in that the in that the “z” and “y” have traded places.

The French alphabet includes too many accented letters to fit on the single row, therefore automatic addition of accents is used (FIG. 3b). Further, the layout is different form the English layout.

Also other languages such as Spanish (FIG. 3c) have too many accented letters to fit on the single row, and also here automatic addition of accents is used. Further, the layout is different form the English layout.

Most of the Scandinavian languages can be covered with a single layout that includes three additional letters.

About 5 to 6 different layouts can cover most American and European languages.

Consistency with the standard phone ITU-T keypad is kept high to allow easy adaptation for mobile phone users. The “ [symbol] ” character is assigned to key “0”, the * keys is assigned the next-function used for a next matching word candidate provided by predictive editing software, and the “#” keys is assigned the shift function for changing between upper case and lower case. The functionality of these keys is the same as used in current Nokia® phones, thereby facilitating users to become accustomed to the one row layout. The Shift-function can be operated on both the leftmost and rightmost key of the row, as in a QWERTY keyboard.

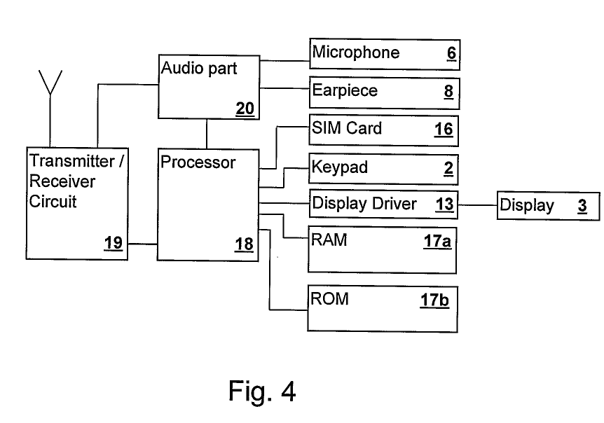

FIG. 4 illustrates in block diagram form the general architecture of the smartphone 1 constructed in accordance with the present invention. The preferred embodiment of the smartphone of the invention is adapted for use in connection with the GSM network, but, of course, the invention may also be applied in connection with other phone networks, such as cellular networks and various forms of cordless phone systems or in multiple band phones accessing sets of these systems/networks.

The microphone 6 records the user's speech, and the analog signals formed thereby are A/D converted in an A/D converter (not shown) before the speech is encoded in an audio part 14. The encoded speech signal is transferred to the controller 18 (physical layer processor), which inter alia supports the GSM terminal software. The controller 18 also forms the interface to the peripheral units of the apparatus, including RAM and ROM memories 17a and 17b, a SIM card 16, the display 3 and the keypad 2 (as well as data, power supply, etc.). The controller 18 communicates with the transmitter/receiver circuit 19. The audio part 14 speech-decodes the signal, which is transferred from the controller 18 to the earpiece 5 via a D/A converter (not shown).

The smartphone is capable of assuming a plurality of different states. It is the controller 18 which detects the occurrence of a mode change event and changes the mode of the smartphone and thus the information in the display. A mode change event may be caused by the user by activating the keypad including the navigation key 10. However, also the cellular network in communication with the smartphone may cause a mode change event e.g. status change during call set-up, change in battery voltage, change in antenna conditions, message on reception of SMS, etc.

Number Entry

When the smartphone 1 is in a number entry mode, as illustrated in FIG. 1, where keypad 2 is used only for number input (e.g. telephone number dialing) the numeric function of the alphanumeric keys is active, and there is no ambiguity since only one digit is assigned to each alphanumeric key. The numbers as they are entered are displayed in a box 30 on the display 3. A cursor 22 that is movable by means of the navigation key 10 indicates the location at which the next number will be added. After entry of the first digit the functionality of the left softkey 8 changes to “Call” so that a user may initiate the establishment of a phone call by a single activation of the left softkey. After entry of the first digit the functionality of the right softkey 9 changes to “Clear” so that a user may delete entered digits for correction purposed by pressing the right softkey 9. Other embodiments according to the invention may be provided with a hard labeled clear key.

Text Entry

The editor program allows two modes for entering text: multitap and predictive editing, the latter eventually combined with word completion. These methods are well known in the art for example from US2003/0104839A1, hereby incorporated by reference.

The smartphone includes a character entry application. FIG. 2 shows the smartphone in the alpha mode (indicated by symbol 35) while writing an e-mail message. When user input is needed in application programs, such as an SMS or e-mail message handling application, a WAP or www browser application, and for searching in phonebook records, the processor 18 opens the character entry application in which the user may enter characters and use the entered character strings in the application from which the character entry application is opened.

The processor 18 executes instructions and reads data from and writes data in the memory 17b. The character entry application has software instructions in the memory 17b including an operating system, a disambiguation program and its vocabularies—one for each language supported by the editor, a user defined vocabulary (e.g. words copied from the phonebook and manually entered by multi-tapping).

The disambiguation program records key stroke sequences inputted for characterizing words to be entered, and compares the key stroke sequences with word candidates in a vocabulary in order to find word candidates matching the entered key stroke sequence. The best matching word candidate 40 is shown in the display and can be accepted by the user. The disambiguation program keeps a record of the current key sequence until the user has accepted a word based on this sequence by pressing the space key, e.g. by short pressing (shorter than e.g. 0.8 sec) of the “0” key of alphanumeric keys.

The displayed word candidate 40 is marked by underlining until the user has accepted the word candidate. As long as the word candidate is underlined, characters can be added by pressing any of the alphanumerical keys except the “0” key, characters can be deleted by activating the right softkey 9 that is labeled “Clear”, and the next matching word candidate provided by the disambiguation program can be selected by activating the “*” key. By repetitive activation of the “*” all matching word candidates are displayed one after another in a closed loop manner. After one completion of the loop the left softkey 8 changes to “Spell”.

The character entry application may further include a word completion program that compares the entered key stroke sequence with word completion candidates (not shown) in a word completion directory in order to find word completion candidates matching the key stroke sequences. One of said matching word completion candidates is displayed in the display for selection by the user.

In the alpha mode, both the “*” key and the “#” key, i.e. rightmost and leftmost key are assigned to the shift function, to change between small cap and large cap letters.

For entering words that are not present in the vocabularies the multitap character entry method is used.

The user can switch to the multitap mode at any time via the “Options” that are accessed by pressing the left softkey 8. When the disambiguation program cannot find any matching word for an entered key stroke sequence, the softlabel of the left softkey 8 automatically changes to “Spell”, thus providing a shortcut to the multitap mode.

Basic punctuation, e.g. full stop and comma, are entered by pressing either of the shift keys together with the space “0” key. Other punctuation characters are entered in a separate “special characters” menu accessed by activating the “*” key when there is no underlined word candidate in the display.

For facilitating the entry of numbers in a text the user can either switch to a number entry mode via the left softkey “Option” or by activating “#” key longer than a predetermined threshold (e.g. longer than 0.8 sec). The character entry application returns to the text entry mode by a renewed long activation of the “#” key. Alternatively, or in addition, the switch between text and number entry may be achieved by pressing the “*” and the “#” shift keys at the same time.

Numbers can also be entered by pressing any of the alphanumerical keys longer than a predetermined threshold (e.g. longer than 0.8 sec). In this case the mode of the character entry program only changes temporarily.

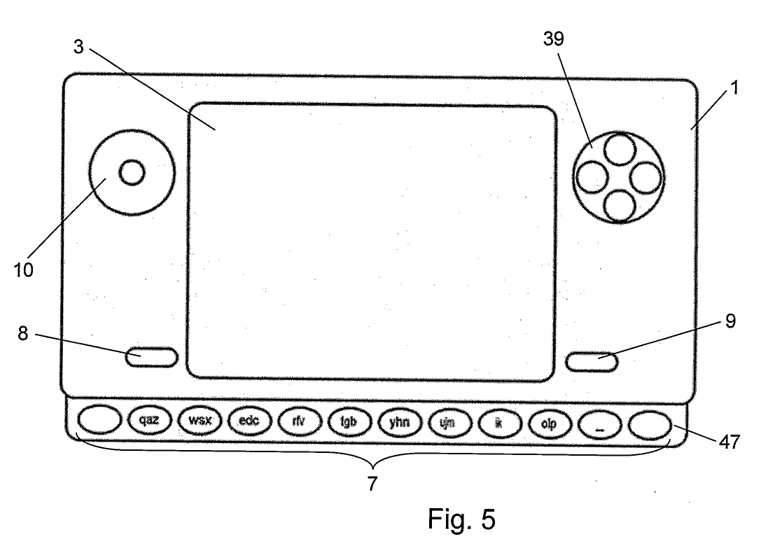

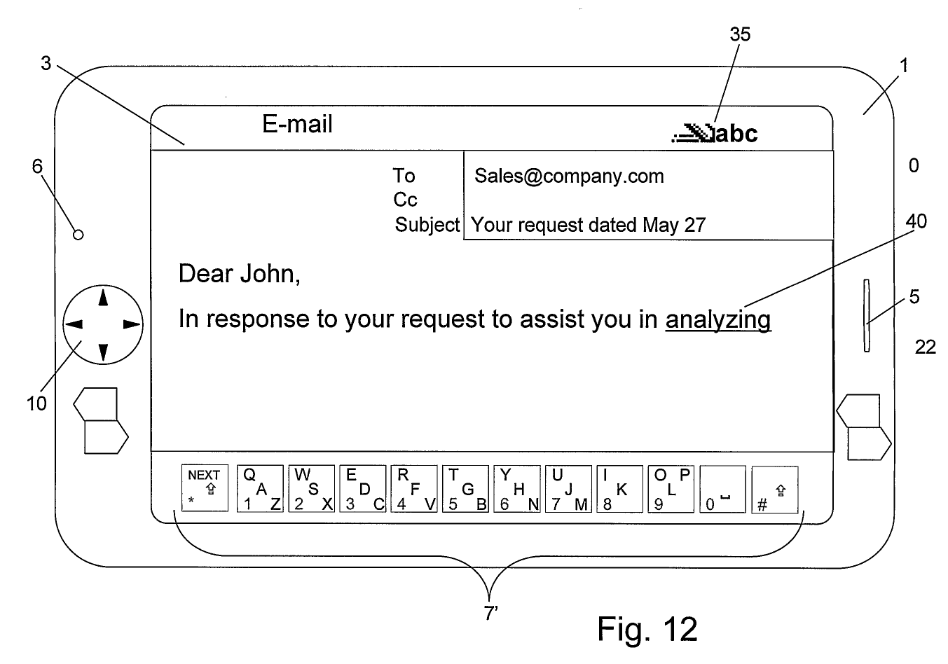

FIGS. 5 to 12 show other preferred embodiments according to the invention. The same features of the embodiment shown in FIGS. 1 to 4 have the same reference numerals in FIGS. 5 to 12.

FIG. 5 shows a second embodiment that is substantially identical with the first embodiment. However, the terminal according to the second embodiment is a gaming terminal in which the display and the input devices optimized for game play. Therefore, the terminal according to the second embodiment includes a game controller 39. Further, the terminal is provided with a slide 47, on which the row of keys 7 is disposed. The slide 47 can move between a retracted position (not shown) and an extended position shown in FIG. 5. in the extended position in the single row of keys can be used for data input, also during gameplay.

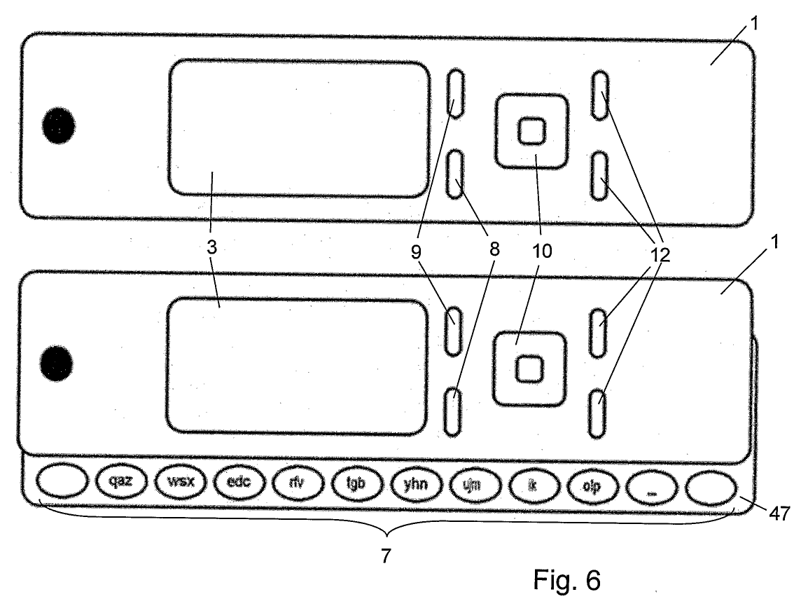

FIG. 6 shows a third embodiment in the form of a mobile phone 1 with an elongated housing. The terminal according to the third embodiment is provided with a slide 47 with the single row of keys 7 disposed thereon. Similar to the second embodiment, the slide can move between a retracted position in which it simultaneously covers a lens of a digital camera (not shown), and an extended position in which it simultaneously uncovers the lens of the digital camera. Further, of the terminal according to this embodiment includes call handling keys 12.

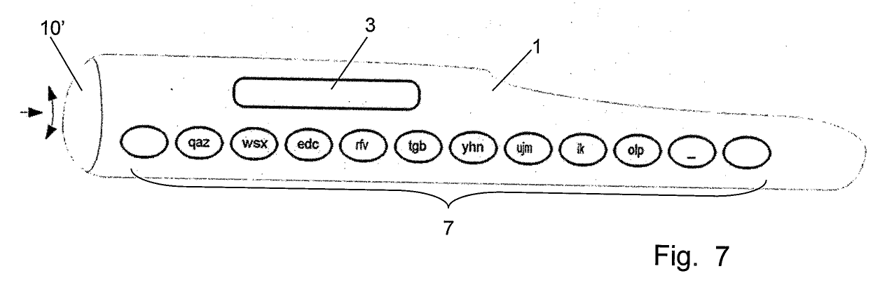

FIG. 7 shows a fourth embodiment in the form of a pen shaped mobile phone 1. The mobile phone 1 is provided with a one-line display 3 and a roller 10′ for navigation (by rotation) and selection (by depression).

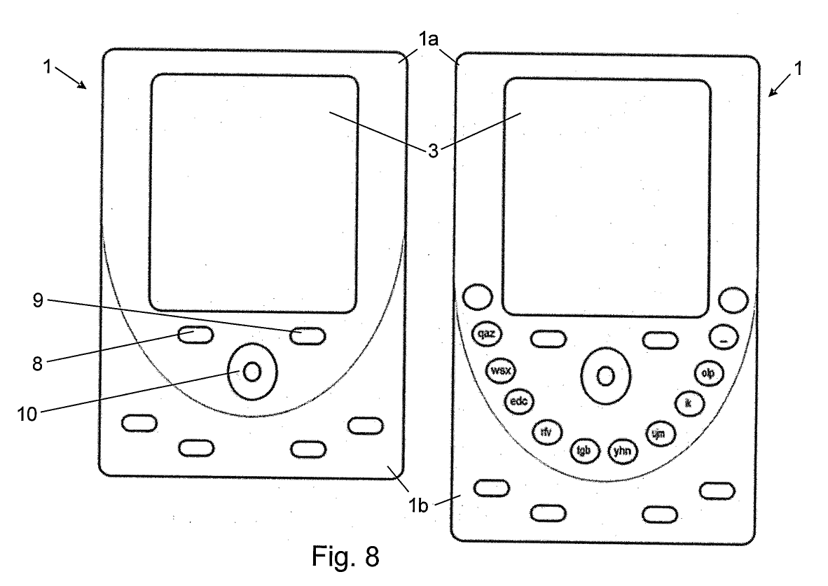

FIG. 8 shows a fifth embodiment in the form of a mobile phone 1 provided with a two-parted slidably connected housing. The display 3 is provided in the upper housing part 1a and the row of keys 7 is disposed on the lower housing part 1b. In the retracted position, the row of keys 7 is obscured by the upper housing part 1a and in the extended position the row of keys can be accessed. The row of keys 7 is arranged along a curved line.

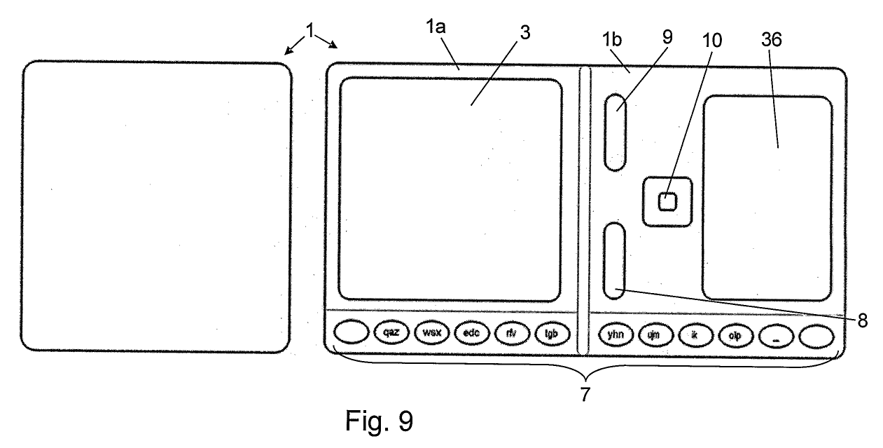

FIG. 9 shows a sixth embodiment in the form of a handheld computer 1 with a folding housing construction. The display 3 and the row of keys 7 are disposed on the left housing part 1a. The soft keys 8 and 9, the navigation key 10, the other halve of the row of keys 7 and a touch pad 36 are disposed on the right housing part 1b.

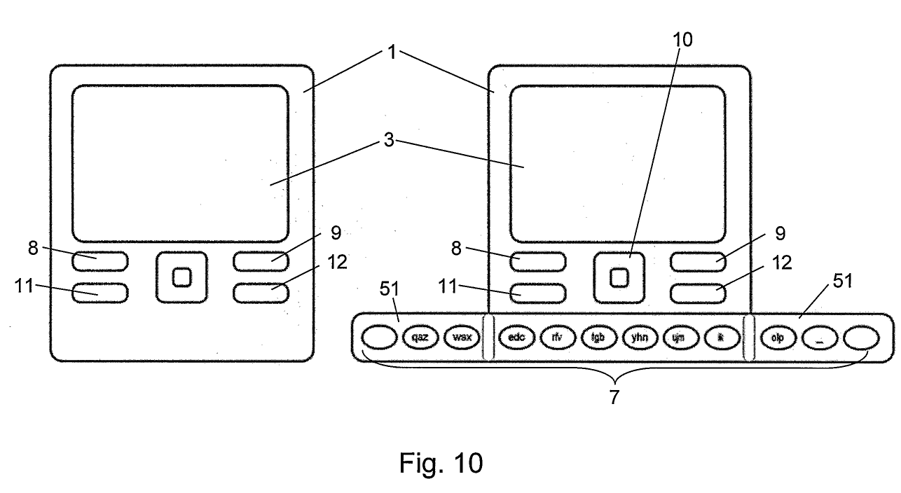

FIG. 10 shows a seventh embodiment in the form of a mobile phone 1 provided with two foldable flaps 51. Half of the keys in the row 7 are disposed on the lower part of the housing of the mobile phone 1, and obscured by the flaps 51 when they are in their retracted position. The three leftmost keys of the row are disposed on the left flap 51 and the three rightmost keys of the row are disposed on the right flap 51. The phone is further provided with a display 3, a left softkey 8, a right softkey 9, an off-hook key 11, an on-hook key 12 and a four-way plus selection key 10.

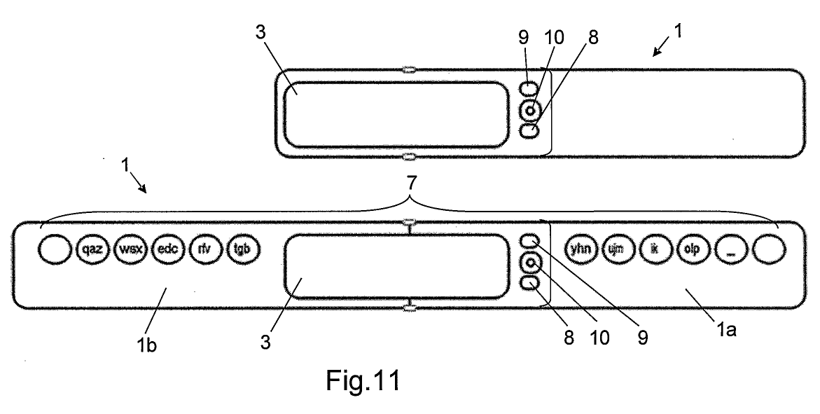

FIG. 11 shows an eighth embodiment in the form of a mobile phone 1 with a folding housing construction in which the folding axis coincides with a center line of the display 3. When the housing is closed, the mobile phone 1 is used in the upright position and the soft keys 8,9 and the navigation key 10 are located under the display 3. One halve of the row of keys 7 is disposed on the left housing part 1b the and the other halve of the row of keys 7 is disposed on the right housing part 1a. When the housing is folded open, the orientation of the information on the display is rotated to 2700 and the row of keys 7 can be used for data entry.

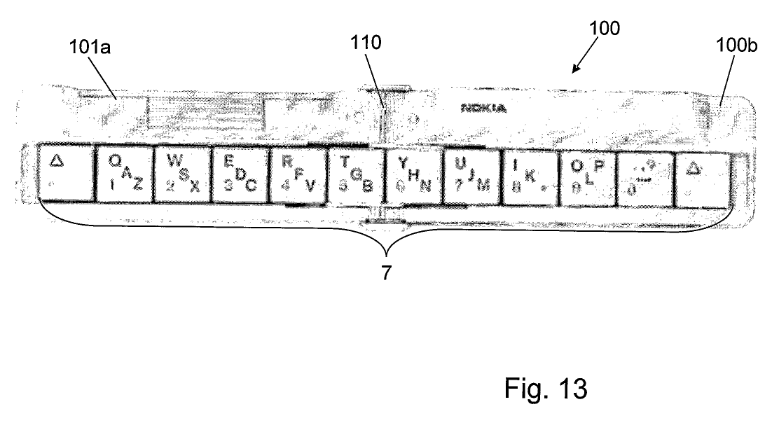

FIG. 13 shows a ninth embodiment in the form of a mobile

smartphone 1 that is provided with a touch screen 3. The row of keys is implemented as a virtual key-row 71. The absence of a row of physical keys allows the display 3 to be larger when compared to the first embodiment. Data is entered by touching the keys of the virtual key-row 7′, and the operation of the character entry program is identical with the first embodiment.

FIG. 14 shows a tenth embodiment in the form of a mini accessory keypad 100. The mini accessory keypad 100 includes a left housing part 101a and a right housing part 101b that are foldably connected to one another by a hinge 101. In the shown open position the user has access to be row of keys 7, and in the closed position the keys are protected from being inadvertently activated. The accessory keypad 100 includes its own battery and a short range RF (Bluetooth) transceiver for communicating keystrokes to a similarly equipped communication terminal in which the data is to be entered.

Although the disclosed embodiments have been described in detail for purpose of illustration, it is understood that such detail is solely for that purpose, and variations can be made therein by those skilled in the art without departing from the scope of the invention.

1. A mobile communication terminal comprising:
a display;
a keypad comprising a single row of keys, at least some of said keys having a plurality of characters associated therewith in one or more states of the terminal; and
processor means controlling the display means in accordance with the operation of the keypad;
said processor means being configured to disambiguate ambiguous keystrokes; and
said single row of keys being disposed along the periphery of the display.

2. A terminal according to claim 1, wherein the single row of keys is disposed along a side of the display, preferably relatively nearby said side of the display.

3. A terminal according to claim 2, wherein other keys of said keypad are disposed along the other sides of the display.

4. A terminal according to claim 1, wherein said single row is disposed below the display.

5. A terminal according to claim 1, wherein said keypad includes at least one soft labeled key, whereby a predetermined area, preferably the lower band of said display, is used for displaying softlabels, and said at least one soft labeled key is preferably disposed on the left and/or right side of the display.

6. A terminal according to claim 1, wherein the display is used in the landscape orientation during normal use.

7. A terminal according to claim 1, comprising a stationary housing part on which the display is disposed and a movable housing part on which said single row of keys is disposed.

8. A terminal according to claim 7, wherein said movable housing part is a retractable slide.

9. A terminal according to claim 7, wherein said movable housing part is a folding flap or housing part.

10. A terminal according to claim 1, wherein said single row of keys is disposed on two or more movable housing parts.

11. A terminal according to claim 1, wherein said row is arranged along a curved line.

12. A terminal according to claim 1, wherein said display is a touchscreen and said single row is keys is a virtual row of keys displayed on the touchscreen.

13. A mobile communication terminal comprising:
a display;
a keypad comprising a single row of keys, said row of keys including at least several keys having a plurality of characters associated therewith in a text entry mode of the terminal;
processor means controlling the display means in accordance with the operation of the keypad; and
said processor means being configured to disambiguate ambiguous keystrokes by determining word candidates that match a string of entered keystrokes, and to show one of said matching word candidates on the display;
said single row of keys further including:
a key associated with the function of accepting a word candidate and/or adding a space after the last entered character in a text entry mode of the terminal.

14. A mobile communication terminal according to claim 13, wherein said single row of keys further includes a key associated with a shift function in a text entry mode of the terminal.

15. A mobile communication terminal according to claim 13, wherein said single row of keys further includes a key associated with a function of selecting/displaying another word candidate that matches the string of entered keystrokes.

16. A mobile communication terminal according to claim 13, wherein said processor is configured to shift between a text entry mode and a number entry mode when two predetermined keys are activated simultaneously.

17. A mobile communication terminal according claim 13, wherein a limited number of special characters is entered by simultaneously activating two predetermined keys in the row of keys.

18. A mobile communication terminal according to claim 13, wherein the display is a touch screen and the single row of keys is displayed in the display as a virtual row of keys, preferably in the lower part of the display just above the lower side thereof.

19. A mobile communication terminal according to claim 13, wherein said single row of keys includes
at least ten keys that are each associated with a different one of the ten digits in a telephone number entry mode of said terminal.

20. A mobile communication terminal according to claim 13, wherein said single row of keys includes
a key associated with the asterisk “*” symbol in the telephone number entry mode of said terminal.

21. A mobile communication terminal according to claim 13, wherein said single row of keys includes
a key associated with the square “#” symbol in the telephone number entry mode of said terminal.

22. A mobile communication terminal that is capable of handling telephone calls comprising:
a display;
a keypad comprising a single row of keys;
said single row of keys including:
at least ten keys that are each associated with a different one of the ten digits in a telephone number entry mode of said terminal;
a key associated with the asterisk “*” symbol in the telephone number entry mode of said terminal; and
a key associated with the square “#” symbol in the telephone number entry mode of said terminal.

23. A mobile communication terminal according to claim 22, wherein said processor is configured to shift between a text entry mode and a number entry mode when said key associated with the “*” symbol and said key associated with the “#” symbol are pressed simultaneously.

24. A mobile communication terminal according to claim 23, wherein said telephone calls are transmitted via a cellular network.

25. A mobile communication terminal according to claim 23, wherein said telephone calls are transmitted via the internet, preferably in a voice-over-IP protocol.

26. A mobile communication terminal according to claim 22, wherein said mobile communication terminal is a mobile phone.

27. A keypad for use with a mobile computer terminal, said keypad comprising a single row of keys; wherein said single row of keys includes:
at least several keys having a plurality of characters associated therewith; and
a key associated with the function of accepting a word candidate and/or adding a space after the last entered character.

28. A keypad according to claim 27, wherein said single row of keys further includes a key associated with a shift function in a text entry mode of the terminal.

29. A keypad according to claim 27, wherein said single row of keys further includes a key associated with a function of selecting another word candidate that matches a string of entered keystrokes.

30. A keypad according to claim 27, wherein said single row of keys includes at least ten keys that are each associated with a different one of the ten digits.

31. A keypad according to claim 31, wherein said single row of keys includes a key associated with the asterisk “*” symbol in the telephone number entry mode of said terminal.

32. A keypad according to claim 27, wherein said single row of keys includes a key associated with the square “#” symbol in the telephone number entry mode of said terminal.

33. A keypad according to claim 27, wherein said keys of said single row are labeled with the characters and/or functions that are assigned thereto.

34. A keypad according to claim 27, wherein said keypad is an accessory keypad for connecting to a mobile communication terminal.

35. A keypad according to claim 34, having its own housing, wherein said housing preferably comprises two parts that are foldably connected to one another.

36. A keypad according to claim 35, wherein said foldably connected housing parts can be moved between an open position and a closed position, the row of keys being accessible by a user in the open position and the row of keys being protected from inadvertedly being activated in the closed position.

37. A keypad for use with a hand-held communication terminal, comprising a single row of keys; wherein said single row of keys includes:
at least ten keys that are each associated with a different one of the ten digits in a telephone number entry mode of said terminal;
a key associated with the asterisk “*” symbol in the telephone number entry mode of said terminal; and
a key associated with the square “#” symbol in the telephone number entry mode of said terminal.

38. A keypad according to claim 37, wherein said single row of keys includes at least several keys having a plurality of characters associated therewith.

39. A keypad according to claim 37, wherein said single row of keys includes a key associated with the function of accepting a word candidate and/or adding a space after the last entered character.

40. A keypad according to claim 37, wherein said single row of keys further includes a key associated with a shift function in a text entry mode of the terminal.

41. A keypad according to claim 37, wherein said single row of keys further includes a key associated with a function of selecting/displaying another word candidate that matches a string of entered keystrokes.

42. A keypad according to claim 37, wherein said keys of said single row are labeled with the characters and/or functions that are assigned thereto.

43. A keypad according to claim 37, wherein said keypad is an accessory keypad for connecting to a mobile communication terminal.

44. A keypad according to claim 43, having its own housing, wherein said housing preferably comprises two parts that are foldably connected to one another.

45. A keypad according to claim 44, wherein said foldably connected housing parts can be moved between and open position and a closed position, the row of keys being accessible by a user in the open position and the row of keys being protected from inadvertedly being activated in the closed position.
